(19) United States
(12) Patent Application Publication
(10) Pub. No.: US 2026/0358880 A1
(43) Pub. Date: Nov. 12, 2026

(54) POWER MANAGEMENT FOR PROCESSOR CIRCUITS

(71) Applicant: Texas Instruments Incorporated, Dallas, TX (US)

(72) Inventors: Anish Reghunath, Allen, TX (US); Francisco Adolfo Cano, Sugar Land, TX (US); Jason A. T. Jones, Richmond, TX (US); Gregory R. Shurtz, Houston, TX (US); Harshil AtulKumar Shah, McKinney, TX (US); Duc Quang Bui, Grand Prairie, TX (US); Timothy David Anderson, University Park, TX (US)

(21) Appl. No.: 19/436,838

(22) Filed: Dec. 30, 2025

Related U.S. Application Data
(60) Provisional application No. 63/803,996, filed on May 12, 2025.
(60) Provisional application No. 63/804,000, filed on May 12, 2025.

(51) Int. Cl. G06F 1/3296; G06F 1/324

(52) U.S. Cl. CPC G06F 1/3296; G06F 1/324

(57) ABSTRACT

An example device includes interface circuitry. The device includes at least one programmable circuit coupled to the interface circuitry and configurable to: determine, based on an amount of data to be processed, a number of slices of a processor circuit to enable to process the data; and enable the number of slices of the processor circuit to process the data. Other examples are described.

### CROSS-REFERENCE TO RELATED APPLICATION

This patent application claims the benefit of and priority to U.S. Provisional Patent Application No. 63/803,996 filed May 12, 2025, and U.S. Provisional Patent Application No. 63/804,000 filed May 12, 2025. U.S. Provisional Patent Application No. 63/803,996 filed May 12, 2025, and U.S. Provisional Patent Application No. 63/804,000 filed May 12, 2025, are hereby incorporated herein by reference in their entirety.

### TECHNICAL FIELD

This description relates generally to power management and, more particularly, to power management for processor circuits.

### BACKGROUND

Matrix multiplication is a mathematical operation that produces a matrix from two matrices. For example, a first matrix (also referred to as an A matrix) and a second matrix (also referred to as a B matrix) are multiplied together to produce a third matrix (e.g., also referred to as a C matrix). Matrix multiplication is relevant in many different technical environments such as software engineering (e.g., graphics and game development, artificial intelligence (AI)/machine learning (ML), computer vision, cryptography, etc.), electrical engineering (e.g., controls, signal processing, robotics), and mechanical engineering (e.g., finite element analysis, vibration analysis, thermal systems, etc.). AI/ML applications utilize matrix multiplication extensively. For example, every layer of a neural network (NN) utilizes matrix multiplication to some extent.

### SUMMARY

For improving processor circuits, an example device includes interface circuitry. The device includes at least one programmable circuit coupled to the interface circuitry and configurable to: determine, based on an amount of data to be processed, a number of slices of a processor circuit to enable to process the data; and enable the number of slices of the processor circuit to process the data. Other examples are described.

For improving matrix multiplication accelerators, an example system includes an processor circuit having at least two slices. The system includes at least one programmable circuit coupled to the processor circuit and configurable to determine, based on an amount of data to be processed, a number of slices of the processor circuit to enable to process the data. The system includes a power management circuit coupled to the processor circuit and coupled to the at least one programmable circuit, the power management circuit configurable to: identify the number of slices of the processor circuit to enable to process data based on an indication from the at least one programmable circuit, and enable the number of slices to process the data. The system includes where the at least one programmable circuit is configurable to provide the data to the processor circuit. Other examples are described.

For improving processor circuits, an example processor circuit includes a first slice configurable to be selectively enabled responsive to a first signal from a power management circuit. The processor circuit includes a second slice configurable to be selectively enabled responsive to a second signal from the power management circuit. The processor circuit includes a core circuit configurable to be enabled coincidentally with the first slice. Other examples are described.

### BRIEF DESCRIPTION OF THE DRAWINGS

FIG. 1 is a block diagram of an example system in which an example programmable circuitry cluster offloads matrix multiplication operations to an example analytics cluster.

FIG. 2 is a block diagram of an example analytics worker that can implement one or more of the analytics workers of FIG. 1.

FIG. 3 is a timing diagram of an example operational procedure for the matrix multiplication accelerator (MMA) of FIG. 2, according to an embodiment of the present disclosure.

FIG. 4 is an illustration of an example state machine that may be utilized by the analytics power management circuit of FIG. 2 to control power supplied to the MMA of FIG. 2.

FIG. 5 is a block diagram of an example analytics cluster that can implement the analytics cluster of FIG. 1.

FIG. 6 is an illustration of an example state machine that may be utilized by the analytics power management circuit of FIG. 5 to control power supplied to the MMA of FIG. 5.

FIG. 7 is a block diagram of the analytics cluster of FIG. 5 depicting an example use case when the size of matrices for a matrix multiplication operation will not fully occupy one of the MMAs of FIG. 5.

FIG. 8 is a flowchart representative of example machine-readable instructions or example operations that may be at least one of executed, instantiated, or performed using an example programmable circuitry implementation of the digital signal processors of FIGS. 2 and/or 5 to determine how many slices of one or more of the MMAs of FIGS. 2 and/or 5 for a matrix multiplication operation.

FIG. 9 is a flowchart representative of example machine-readable instructions or example operations that may be at least one of executed, instantiated, or performed using an example programmable circuitry implementation of the analytics power management circuits of FIGS. 2 and/or 5 to enable one or more of the MMAs of FIGS. 2 and/or 5 for a matrix multiplication operation.

FIG. 10 is a flowchart representative of example machine-readable instructions or example operations that may be at least one of executed, instantiated, or performed using an example programmable circuitry implementation of the analytics power management circuits of FIGS. 2 and/or 5 to manage power consumption by one or more of the MMAs of FIGS. 2 and/or 5.

FIG. 11 is a block diagram of an example processing platform including programmable circuitry structured to execute, instantiate, or perform the example machine-readable instructions or perform the example operations of FIGS. 8-10 to implement the analytics power management circuit of FIG. 2, FIG. 5, and/or FIG. 7.

FIG. 12 is a block diagram of an example software/firmware/instructions distribution platform (e.g., one or more servers) to distribute software, instructions, or firmware (e.g., corresponding to the example machine-readable instructions of FIGS. 8-10) to client devices associated with end users or consumers (e.g., for license, sale, or use), retailers (e.g., for sale, re-sale, license, or sub-license), or original equipment manufacturers (OEMs) (e.g., for inclusion in products to be distributed to, for example, retailers or to other end users such as direct buy customers).

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

Matrix multiplication is used extensively in modern computing. From AI/ML applications to computer vision and driving assistance, matrix multiplication is a fundamental computational task in modern computing. While broadly used, matrix multiplication is a computationally complex task. As such, many compute devices include a hardware matrix multiplication accelerator (MMA) to perform matrix multiplication operations more efficiently. An MMA includes specialized hardware to perform matrix multiplication operations in a computationally efficient manner. For example, the dedicated hardware is structured for the specific task of matrix multiplication and can perform matrix multiplications more efficiently than a general-purpose processor such as a central processor unit.

As described above, matrix multiplication is a fundamental computational task in AI/ML applications. In many applications such as advanced driver assistance systems (ADAS) and in-vehicle infotainment (IVI), convolutional neural networks (CNNs) perform convolutions on images to analyze an environment, for example, around a vehicle. To perform a convolution on an image (also referred to as an input feature map), a two-dimensional (2D) kernel matrix is multiplied by a 2D matrix of image data and iterated or stepped across the image to generate different “views” of the image. The products generated by multiplying respective elements of the kernel matrix and corresponding elements of the matrix of image data are summed together to produce a single row. After the full input feature map has been multiplied by the 2D kernel matrix, the resulting values from respective matrix multiplications form a 2D output matrix (also referred to as an output feature map).

Because matrix multiplications are offloaded to an MMA on an as needed basis, MMAs operate with an irregular frequency (e.g., are bursty). As such, the MMA frequently turns on and off. For example, when an operation is offloaded to an MMA, the MMA goes through a three-stage process to turn on. In a first stage, the MMA transitions from an off state to an active operating state where all clocks of the MMA are running. In a second stage, the MMA transitions from the active operating state to a receiving instructions operating state where the MMA loads data to be processed. In a third stage, the MMA transitions from the receiving instructions operating state to an on operating state where the MMA performs a matrix multiplication based on the data loaded into the MMA. After the MMA performs the matrix multiplication, the MMA transitions back to the off operating state.

As such, the current drawn by an MMA varies greatly during the three-stage process. Additionally, because MMAs frequently turn on and off as matrix multiplications are offloaded, the amount of current drawn by an MMA differs greatly over time. The large swings in the amount of current drawn by an MMA cause the supply voltage to the MMA to droop. To counteract voltage droop, the minimum supply voltage to an MMA can be increased. As a result of an increased supply voltage, the overall power consumption of an MMA also increases. An increased supply voltage also increases the monetary cost of packaging an MMA, increases the complexity of the design of the MMA, and reduces ease with which end-users can integrate the MMA into a larger system. For example, the increased power consumption of an MMA increases the thermal impact of the MMA on an overall system. As such, end-users may need to implement heat sinks, thermal interface material, liquid cooling, and/or increased air flow to reduce the thermal impact of an MMA on an overall system.

To regularize power consumption, some MMAs implement an activity levelling mode (ALM) where an MMA processes synthetic data when data has not been offloaded to the MMA. For example, in any clock cycle when ALM is enabled and actual data is not offloaded to an MMA, the MMA multiplies synthetic operands and discards the result of the operation. By processing synthetic data during ALM, the change in current drawn by an MMA over time (e.g., di/dt) is reduced. As such, the power consumption of an MMA implementing ALM is regularized and droop in the supply voltage to the MMA is mitigated. For example, during ALM, an MMA consumes power similar to when the MMA is in the on operating state. Examples of ALM are described in commonly assigned U.S. Patent Application Publication No. 2024/0037180, published Feb. 1, 2024, entitled “Transient Current Management,” which is hereby incorporated herein by reference in its entirety.

As AI/ML is adopted in more applications, there is a demand for MMAs to perform more operations. To increase the number of tera-operations per second (TOPS) performed by an MMA, the size of the process node to manufacture the MMA can be decreased. For example, with a 16 nanometer (nm) process node, an MMA can perform between 8 and 32 TOPS when operating at 1 gigahertz (GHz) whereas with a 5 nm process node, an MMA can perform between 96 and 392 TOPS when operating at 1.5 GHZ (e.g., a 12 times increase in TOPS). With increased TOPS performed by an MMA, the power consumption by the MMA increases and the change in current drawn by the MMA over time also increases.

Additionally, as the size of the process node to manufacture an MMA decreases, a greater number of MMAs can be integrated into the same integrated circuit (IC). As the number of MMAs integrated in an IC increases, the amount of power drawn by the IC increases and the change in current drawn by the IC over time also increases. Thus, to reduce the size of the process node used to manufacture an MMA, power consumption by the MMA and change in current drawn by the MMA over time can also be reduced. While ALM regularizes the power consumption of an MMA, ALM also increases the average power consumption by the MMA. For example, because ALM cannot be dynamically turned on or off, an MMA continues to process synthetic data even during long periods where actual data has not been offloaded to the MMA.

Advantageously, examples described herein reduce power consumption (both dynamic power consumption and leakage power consumption) of an MMA as well as the current drawn by the MMA over time. As such, the size of the process node to manufacture an MMA can be reduced. For example, described examples include an analytics power management circuit (also referred to as a power management circuit) and a slice-based MMA. Each slice of the example MMA described herein has a separate power domain which provides much finer grain control of power consumption by the MMA and noise in the supply voltage to the MMA. Additionally, examples described herein include selectively enabling slices of the MMA to match an amount of data offloaded to the MMA. As such, power consumption by the MMA can be optimized to match the amount of data offloaded to the MMA.

While this disclosure references power management for MMA as an example, the power management techniques described herein may be applied to any type of processor circuit. For example, the power management techniques may be applied to accelerators, processors, or any other type of logic circuit. Furthermore, the power management techniques may be applied to processor circuits that include one or more slices.

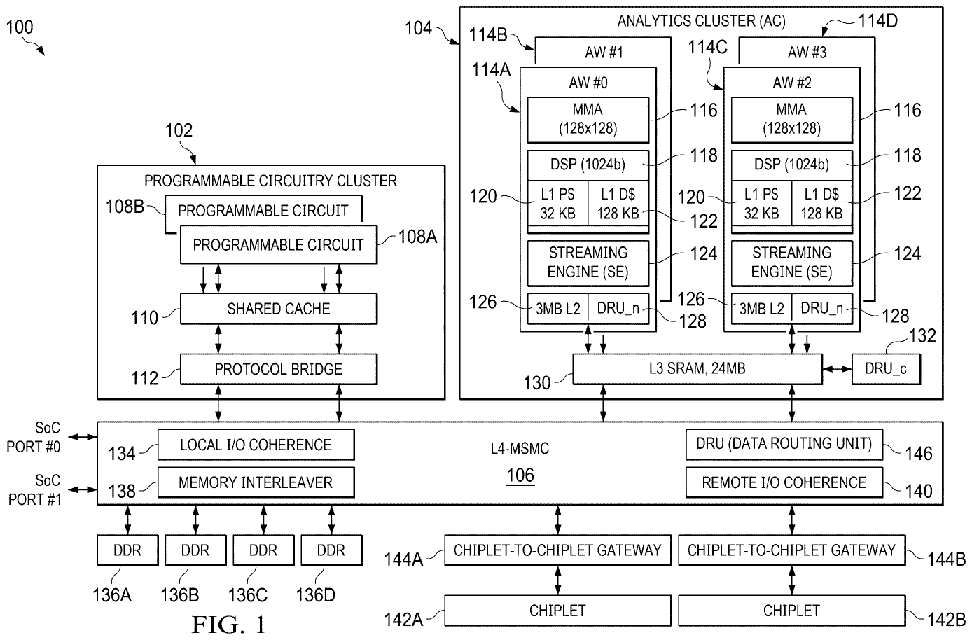

FIG. 1 is a block diagram of an example system 100 in which an example programmable circuitry cluster 102 offloads matrix multiplication operations to an example analytics cluster 104. For example, the programmable circuitry cluster 102 and the analytics cluster 104 are in communication via an example multicore shared memory controller (MSMC) 106. In the example of FIG. 1, the system 100 is a system-on-chip (SoC) that processes, stores, and/or causes display of data related to driving assistance and/or infotainment (e.g., ADAS and/or IVI). In some examples, the system 100 is an SoC that processes, stores, or causes display of data, for example, related to a security system, a recording system, etc.

In some examples, the system 100 is an SoC that processes, stores, or causes display of multi-media data (e.g., images, videos, etc.) from one or more sensors, such as cameras related to a camera system. In other examples, the system 100 is an SoC that processes, stores, or causes display of an alternative type of data from one or more alternative types of sensors (e.g., lidar, radar, ultrasonic, etc.). In additional or alternative examples, the system 100 is an SoC that processes, stores, or causes display of data related to an industrial application, a signal processing application, or a networking application.

In the illustrated example of FIG. 1, each of the programmable circuitry cluster 102, the analytics cluster 104, and the MSMC 106 is implemented on one or more chiplets that are integrated in the same package. A chiplet, for example, is an IC that performs a subset of functionality and is designed to be combined with other chiplets on an interposer in a single package to create a more complex component such as an SoC or system-in-package (SiP). Chiplets can be implemented in a mix-and-match assembly where chiplets from different manufacturers are mixed and matched together in a single package. Chiplets can be communicatively coupled by standards such as Universal Chiplet Interconnect Express (UCIe), bunch of wires (BoW), Advanced Interface Bus (AIB), Open High Bandwidth Interface (OpenHBI), and Optical Internetworking Forum (OIF) Extra Short Reach (XSR).

In the illustrated example of FIG. 1, the programmable circuitry cluster 102 includes example programmable circuits 108A, 108B, an example shared cache 110, and an example protocol bridge 112. In the example of FIG. 1, each of the programmable circuits 108A, 108B includes layer one (L1) and layer two (L2) caches and at least one processor core. Additionally, in the example of FIG. 1, the shared cache 110 is a layer three (L3) cache that is implemented by eight megabytes (MB) of static random access memory (SRAM). In the example of FIG. 1, the shared cache 110 facilitates process migration between the programmable circuits 108A, 108B. Additionally, the shared cache 110 maintains coherency between the L1 and L2 caches of the programmable circuits 108A, 108B and the L3 cache of the shared cache 110. In the example of FIG. 1, the protocol bridge 112 converts communications implemented according to an internal protocol of the programmable circuitry cluster 102 to an inter-chiplet protocol of the system 100.

In the illustrated example of FIG. 1, the programmable circuitry cluster 102 is communicatively coupled to one or more peripheral devices via the MSMC 106. Example peripheral devices include at least one sensor that obtains information of the surrounding environment, such as images, videos, time of flight measurements, beamforming data, etc. For example, the peripheral devices produce video streams of the environment surrounding a vehicle. In some examples, the programmable circuitry cluster 102 stores, processes, or cause display of data from the peripheral devices. In the example of FIG. 1, the programmable circuitry cluster 102 causes display of the data from one or more of the peripheral devices using a display. Also, the programmable circuitry cluster 102 may also at least one of store or process data from the peripheral devices for other functions, such as object recognition, time of flight calculations, etc.

In the illustrated example of FIG. 1, the analytics cluster 104 includes example analytics workers 114A-114D. In some examples, the analytics cluster 104 is referred to as a deep learning cluster. In the example of FIG. 1, each of the analytics workers 114A-114D includes an example MMA 116 and at least one example programmable circuit 118. For example, the MMA 116 includes compute circuitry to perform matrix multiplication operations on matrices that are up to 128 by 128 elements. In the example of FIG. 1, the at least one programmable circuit 118 is a 1,024-bit digital signal processor (DSP) that formats data for execution by the MMA 116. Each of the at least one programmable circuit 118 includes an example L1 program cache 120 and an example L1 data cache 122. For example, the L1 program cache 120 is implemented by 32 kilobytes (KB) of SRAM and the L1 data cache 122 is implemented by 128 KB of SRAM.

In the illustrated example of FIG. 1, each of the analytics workers 114A-114D also includes an example streaming engine 124, an example L2 cache 126, and an example data routing unit (DRU) node 128. In the example of FIG. 1, the streaming engine 124 facilitates quick loading of program instructions and/or data from the L2 cache 126 to the functional units of the at least one programmable circuit 118. The streaming engine 124 may also be referred to as a memory access circuit that loads data into memory. In the example of FIG. 1, the L2 cache 126 is implemented by 3 MB of SRAM. Additionally, the DRU node 128 is a transfer controller that manages data movement between a corresponding one of the analytics workers 114A-114D and external components. For example, the analytics cluster 104 includes example L3 cache 130 that is implemented by 24 MB of SRAM and the DRU node 128 manages data movement between a corresponding one of the analytics workers 114A-114D and the L3 cache 130. In the example of FIG. 1, the analytics cluster 104 also includes an example DRU controller 132 that manages data movement between the analytics cluster 104 and the MSMC 106.

As described above, the programmable circuitry cluster 102, the analytics cluster 104, and one or more peripheral devices are communicatively coupled via the MSMC 106. In the example of FIG. 1, the MSMC 106 includes example local input/output (I/O) coherence circuitry 134 that maintains coherence between the L1, L2, and/or L3 caches of the programmable circuitry cluster 102 and/or the analytics cluster 104 and example peripheral memories 136A-136D. For example, the peripheral memories 136A-136D are double data rate (DDR) memories that implement layer four (L4) caches. In the example of FIG. 1, the MSMC 106 also includes example memory interleaver circuitry 138 to distribute a common address space across the peripheral memories 136A-136D.

In the illustrated example of FIG. 1, the MSMC 106 also includes example remote I/O coherence circuitry 140. In the example of FIG. 1, the remote I/O coherence circuitry 140 maintains coherence between the L1, L2, and/or L3 caches of the programmable circuitry cluster 102 and/or the analytics cluster 104 and example chiplets 142A, 142B of the system 100 (e.g., an SoC). For example, the remote I/O coherence circuitry 140 communicates with the chiplets 142A, 142B via example chiplet-to-chiplet gateways 144A, 144B. Additionally or alternatively, the remote I/O coherence circuitry 140 maintains coherence between the L1, L2, and/or L3 caches of the programmable circuitry cluster 102 of one or more components external to the system 100 (e.g., off-package from the SoC). In the example of FIG. 1, the MSMC 106 also includes an example DRU 146 that manages data movement between the MSMC 106 and the programmable circuitry cluster 102, the analytics cluster 104, the memories 136A-136D, the chiplets 142A, 142B, and/or one or more components external to the system 100.

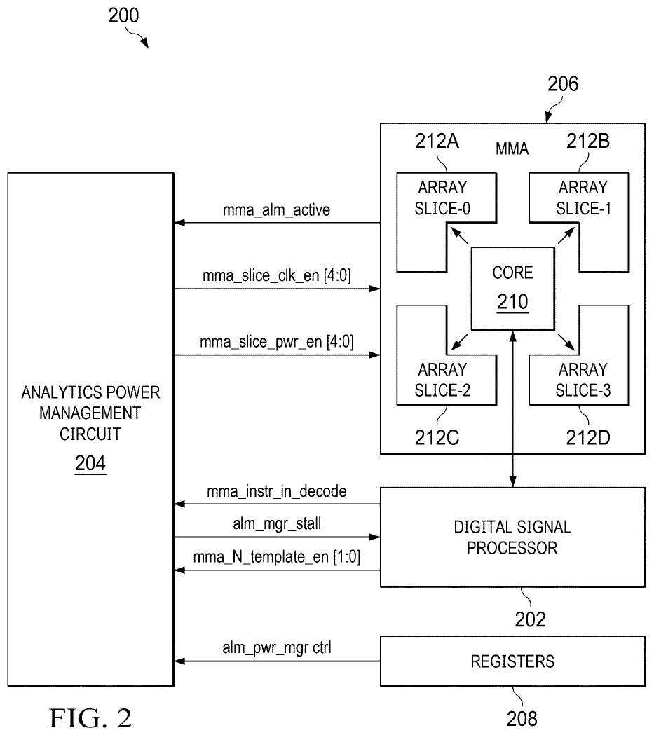

FIG. 2 is a block diagram of an example analytics worker 200 that can implement one or more of the analytics workers 114A-114D of FIG. 1. In the example of FIG. 2, the analytics worker 200 includes an example DSP 202, an example analytics power management circuit 204, an example MMA 206, and example registers 208. Additionally, the analytics worker 200 includes example registers 208. In the example of FIG. 2, the DSP 202, the analytics power management circuit 204, the MMA 206, and the registers 208 are implemented in the same package. For example, the analytics worker 200 is a single IC (such as circuitry implemented on a single semiconductor die or on multiple die but within a single IC package). In the example of FIG. 2, the DSP 202, the analytics power management circuit 204, the MMA 206, and the registers 208 are included on the same semiconductor die. In some examples, the analytics worker 200 may be implemented by two or more ICs in a single IC package to implement a multi-chip module (MCM). In some examples, the DSP 202 and the registers 208, the analytics power management circuit 204, and the MMA 206 are implemented on different dies in the same IC package. In some examples, the DSP 202 and/or the registers 208 may be on a first die, the analytics power management circuit 204 may be on a second die, and the MMA 206 may be on a third die.

In some examples, the analytics worker 200 may be implemented by two or more ICs (such as two or more IC packages). For example, the DSP 202 and the registers 208 may be on a first die in a first IC package and the analytics power management circuit 204 and the MMA 206 may be on a second die in a second IC package. In some examples, the DSP 202 and/or the registers 208 may be on a first die, the analytics power management circuit 204 may be on a second die, and the MMA 206 may be on a third die in the same or multiple IC packages. Alternatively, one or more hardware circuit components of the analytics worker 200 may be included in the DSP 202, the analytics power management circuit 204, the MMA 206, the registers 208, or even implemented on an additional IC. In some examples, the IC packages of the analytics worker 200 may be different materials. In such examples, the different IC packages may have different temperatures or process variations.

In the illustrated example of FIG. 2, the DSP 202 is implemented by programmable circuitry such as one or more general purpose semiconductor-based electrical circuits programmable with instructions to perform one or more specific functions(s) or operation(s) and including one or more semiconductor-based logic devices (e.g., electrical hardware implemented by one or more transistors). In the example of FIG. 2, the analytics power management circuit 204 is implemented by programmable circuitry such as one or more special purpose electrical circuits (e.g., an application specific circuit (ASIC)) structured to perform specific operation(s) and including one or more semiconductor-based logic devices (e.g., electrical hardware implemented by one or more transistors). Additionally, the MMA 206 is implemented by programmable circuitry such as one or more special purpose electrical circuits (e.g., an ASIC) structured to perform specific operation(s) and including one or more semiconductor-based logic devices (e.g., electrical hardware implemented by one or more transistors).

In the illustrated example of FIG. 2, the MMA 206 includes an example core circuit 210 and example slices 212A-212D (identified as Array Slices 0-3). In the example of FIG. 2, the core circuit 210 is implemented by programmable circuitry such as one or more special purpose electrical circuits (e.g., an ASIC) structured to perform specific operation(s) and including one or more semiconductor-based logic devices (e.g., electrical hardware implemented by one or more transistors). Additionally, each of the slices 212A-212D include a dot product multiplication circuit, an adder circuit, and an accumulation storage configurable to perform matrix multiplication operations. For example, the dot product multiplication circuit is implemented by an array of AND gates and adders that are configurable to perform binary long multiplication. Additionally, the adder circuit is implemented by an array of adders such as ripple-carry adders, carry-lookahead adders, or carry-save trees. The example accumulation storage is implemented by SRAM and support circuitry to facilitate loading of data into the SRAM and reading data from the SRAM.

In some examples, each of the slices 212A-212D includes a scaling multiplication circuit and a shifter circuit to convert map matrix multiplication results from a fixed-point range to a floating-point range. For example, the scaling multiplication circuit is implemented by an array of AND gates and adders that are configurable to perform binary long multiplication. The scaling multiplication circuit is configurable to determine products between a matrix multiplication result and a scale vector. Additionally, the shifter circuit is implemented by an array of flip-flops and multiplexers or by a multiplier tree. For example, the shifter circuit is configurable to shift a scaled matrix multiplication result to the right (e.g., right shift) based on a shift vector.

In the illustrated example of FIG. 2, the core circuit 210 and each of the slices 212A-212D are implemented in a separate power domain. For example, the core circuit 210 and the slices 212A-212D are implemented separately from one another and the core circuit 210 and each of the slices 212A-212D are supplied by a separate supply voltage. As such, the MMA 206 includes five power domains. In some examples, the core circuit 210 and the slice 212A are included in the same power domain (e.g., are supplied by the same supply voltage).

In the illustrated example of FIG. 2, the core circuit 210 and each of the slices 212A-212D operate based on a separate clock signal. For example, the MMA 206 includes a root clock signal that is fanned out to the core circuit 210 and each of the slices 212A-212D. As such, the core circuit 210 and each of the slices 212A-212D receive a separate clock signal that is based on the root clock signal. In some examples, the core circuit 210 and the slice 212A operate based on the same clock signal (e.g., receive the same clock signal). In some examples, the core circuit 210 and each of the slices 212A-212D receive an independent clock signal that is synchronized with the other clock signals of the MMA 206.

In the illustrated example of FIG. 2, the core circuit 210 and each of the slices 212A-212D are clock gated and power gated. For example, the core circuit 210 and each of the slices 212A-212D include at least two transistors that operate as switches to control whether a clock signal is supplied to (e.g., clock gated) or power is supplied to (e.g., power gated) a corresponding one of the core circuit 210 and the slices 212A-212D. In this manner, the core circuit 210 and each of the slices 212A-212D can be enabled or disabled responsive to respective clock enable signals (identified as mma_slice_clk_en [4:0]) and/or respective power enable signals (identified as mma_slice_pwn_en [4:0]). In some examples, the core circuit 210 and the slice 212A are clock gated and power gated responsive to the same clock enable signal and the same power enable signal.

In the illustrated example of FIG. 2, the DSP 202 and the analytics power management circuit 204 control the MMA 206. For example, the MMA 206 is configurable to perform matrix multiplication operations on matrices that are up to 128 by 128 elements. As described above, each of the slices 212A-212D can be selectively enabled or disabled and are configurable to perform matrix multiplication operations on matrices that are up to 64 by 64 elements. In the example of FIG. 2, when a matrix multiplication operation is offloaded to the analytics worker 200, the DSP 202 provides an alert signal (identified as mma_instr_in_decode) to the analytics power management circuit 204 to indicate that an instruction for the MMA 206 has entered the pipeline of the DSP 202. Based on the instruction, the DSP 202 determines a number of the slices 212A-212D of the MMA 206 to enable for a matrix multiplication operation. For example, the DSP 202 determines the number of the slices 212A-212D to enable based on the amount of data to be processed by the MMA 206.

In the illustrated example of FIG. 2, the DSP 202 provides a slice number notification (identified as mma_N_template_en [1:0]) to the analytics power management circuit 204. For example, the slice number notification is a 2-bit signal where the different states of the signal indicate which of the slices 212A-212D to enable for the matrix multiplication operation. Table 1 below is an example of which of the slices 212A-212D are to be enabled for different states of the slice number notification.

TABLE 1

| State of the Slice | |
|---|---|
| Number Notification | Slices to be Enabled |
| 00 | 212A-212D |
| 01 | 212A |
| 10 | 212A, 212B |
| 11 | 212A-212D |

In the illustrated example of FIG. 2, the analytics power management circuit 204 is responsible for enabling and disabling each of the slices 212A-212D as well as the core circuit 210. For example, the analytics power management circuit 204 accesses the slice number notification from the DSP 202. Based on the slice number notification, the analytics power management circuit 204 identifies a number of the slices 212A-212D to enable for the matrix multiplication operation. Additionally, the analytics power management circuit 204 enables the number of the slices 212A-212D and the core circuit 210.

In the illustrated example of FIG. 2, the analytics power management circuit 204 actively monitors the state of the MMA 206 and determines whether to transition the MMA 206 between states (e.g., from reset to startup, from startup to active, from active to idle, from idle to active, from idle to shutdown, etc.). If the MMA 206 is powered down (e.g., in the reset state), the analytics power management circuit 204 transitions the MMA 206 through a multi-stage startup procedure to enable the MMA 206 (e.g., the core circuit 210 and at least one of the slices 212A-212D).

Although this disclosure describes the example of MMA 206, the techniques of this disclosure can be implemented for other types of processor circuits. For example, the techniques of this disclosure can be implemented for hardware accelerators such as vision processing circuits, audio processing circuits, Fast Fourier Transform (FFT) processing circuits, cryptographic processing circuits, and the like. For processor circuits other than an MMA, the processor circuit may include multiple slices that are implemented in separate power domains and/or based on separate clock signals.

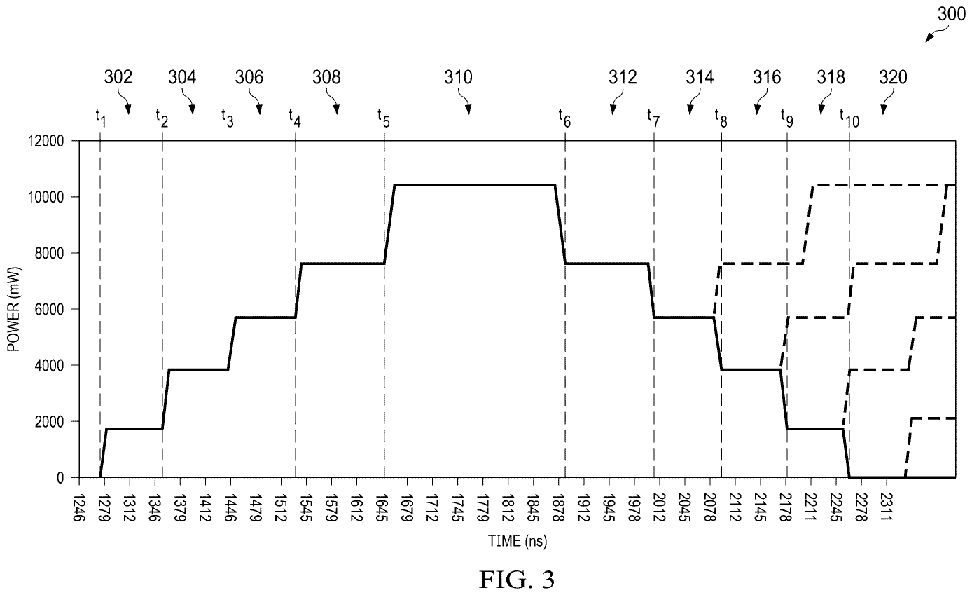

FIG. 3 is a timing diagram of an example operational procedure 300 for the MMA 206 of FIG. 2, according to an embodiment of the present disclosure. In the example of FIG. 3, the analytics power management circuit 204 places the MMA 206 in a first example stage 302 at time t₁. For example, in the first stage 302, the analytics power management circuit 204 asserts power enable signals and the clock enable signals for the core circuit 210 and the slice 212A. Responsive to the asserted power enable signals and the asserted clock enable signals, the core circuit 210 and the slice 212A power up. As such, the power drawn by the MMA 206 steps up from 0 milliwatts (mW) to about 2,000 mW. For example, before time t₁, the MMA 206 is off or in the reset state.

In examples described herein, a signal is asserted when the signal is in an active operating state. In examples described herein, the active operating state of a signal is the logic value at which the signal communicates an enabled state. For example, a power enable signal from the analytics power management circuit 204 is in an active operating state when the power enable signal communicates that power for a corresponding circuit is to be enabled. Also, an asserted signal can be re-asserted without first de-asserting the signal. For example, if power to the core circuit 210 is to remain enabled, the analytics power management circuit 204 continues to assert (re-asserts) the power enable signal to indicate that power is to be provided to the core circuit 210. In examples described herein, a signal being asserted does not necessarily imply the signal has a logic high value. For example, while an active-high signal is asserted when the logic value of the signal is high, an active-low signal is asserted when the logic value of the signal is low.

In the illustrated example of FIG. 3, at time t₂, the analytics power management circuit 204 places the MMA 206 in a second example stage 304. For example, in the second stage 304, the analytics power management circuit 204 asserts a power enable signal and a clock enable signal for the slice 212B. Responsive to the asserted power enable signal and the asserted clock enable signal, the slice 212B powers up. As such, the power drawn by the MMA 206 steps up from about 2,000 mW to about 4,000 mW. In the example of FIG. 3, the period between time t₁ and time t₂ is a programmable value.

In the illustrated example of FIG. 3, at time t₃, the analytics power management circuit 204 places the MMA 206 in a third example stage 306. For example, in the third stage 306, the analytics power management circuit 204 asserts a power enable signal and a clock enable signal for the slice 212C. Responsive to the asserted power enable signal and the asserted clock enable signal, the slice 212C powers up. As such, the power drawn by the MMA 206 steps up from about 4,000 mW to about 5,700 mW. In the example of FIG. 3, the period between time t₂ and time t₃ is a programmable value.

In the illustrated example of FIG. 3, the analytics power management circuit 204 places the MMA 206 in a fourth example stage 308 at time t₄. For example, in the fourth stage 308, the analytics power management circuit 204 asserts a power enable signal and a clock enable signal for the slice 212D. Responsive to the power enable signal and the asserted clock enable signal, the slice 212D powers up. As such, the power drawn by the MMA 206 steps up from about 5,700 mW to about 7,700 mW. In the example of FIG. 3, the period between time t₃ and time t₄ is a programmable value.

After the fourth stage 308, the MMA 206 is fully on (e.g., the core circuit 210 and all of the slices 212A-212D are on) and can perform matrix multiplication operations on matrices that are up to 128 by 128 elements. As such, the stages 302-308 correspond to the startup state of the MMA 206. While the MMA 206 is in the startup state (e.g., the stages 302-308), the analytics power management circuit 204 asserts a stall signal (identified as alm_mgr_stall) and provides the asserted stall signal to the DSP 202. For example, responsive to an alert signal indicating that the DSP 202 has requested processing of the data by the MMA 206, the analytics power management circuit 204 provides the stall signal to delay the DSP 202 from providing the data for a matrix multiplication operation to the MMA 206 until the number of slices of the MMA 206 are enabled. After the MMA 206 exits the fourth stage 308, the analytics power management circuit 204 de-asserts the stall signal and provides the de-asserted stall signal to the DSP 202.

In examples described herein, a signal is de-asserted when the signal is in an inactive operating state. In examples described herein, the inactive operating state of a signal is the logic value at which the signal communicates a disabled state. For example, the stall signal from the analytics power management circuit 204 is in an inactive operating state when the stall signal communicates that stalling of the DSP 202 from providing data to the MMA 206 is disabled. Also, a de-asserted signal can be re-de-asserted without first asserting the signal. For example, once the MMA 206 is powered up, stalling of the DSP 202 from providing data to the MMA 206 is to remain disabled. As such, the analytics power management circuit 204 continues to de-assert (re-de-asserts) the stall signal to indicate that stalling of the DSP 202 from providing data to the MMA 206 is disabled. In examples described herein, a signal being de-asserted does not necessarily imply that the signal has a logic low value. For example, while an active-high signal is de-asserted when the logic value of the signal is low, an active-low signal is de-asserted when the logic value of the signal is high.

In the illustrated example of FIG. 3, at time t₅, the MMA 206 transitions to a fifth example stage 310 where the MMA 206 performs a matrix multiplication operation. For example, the fifth stage 310 corresponds to the active operating state of the MMA 206. As such, the power drawn by the MMA 206 steps up from about 5,700 mW to about 10,300 mW. After the MMA 206 performs a matrix multiplication operation, the MMA 206 enters a sixth example stage 312 at time to. For example, the sixth stage 312 corresponds to ALM where the MMA 206 processes synthetic data and discards the results. For example, the MMA 206 is configurable to process synthetic data during ALM. As such, the power drawn by the MMA 206 steps down from about 10,300 mW to about 8,000 mW. After entering the sixth stage 312, the MMA 206 sends an ALM notification (identified as the mma_alm_active in FIG. 2) to the analytics power management circuit 204.

In the illustrated example of FIG. 3, responsive to the ALM notification, the analytics power management circuit 204 detects that the MMA 206 is in ALM and is processing synthetic data. If the MMA 206 is in ALM for a threshold period, the analytics power management circuit 204 transitions the MMA 206 through a multi-stage shutdown procedure to disable the MMA 206 (e.g., the core circuit 210 and at least one of the slices 212A-212D). As such, the transition from the idle state to the shutdown stage is hardware managed and transparent to software (e.g., executing on the DSP 202 or the programmable circuitry cluster 102). For example, responsive to the MMA 206 processing synthetic data for a threshold period (e.g., the MMA processing synthetic data for threshold period), the analytics power management circuit 204 determines that the MMA 206 is in an idle state. In some examples, the threshold period is a programmable value.

In the illustrated example of FIG. 3, responsive to determining that the MMA 206 is in an idle state, the analytics power management circuit 204 shuts down or disables the MMA 206. For example, at time t₇, the analytics power management circuit 204 places the MMA 206 in a seventh example stage 314. In the seventh stage 314, the analytics power management circuit 204 de-asserts the power enable signal for the slice 212D. In some examples, the analytics power management circuit 204 also de-asserts the clock enable signal for the slice 212D. Responsive to the de-asserted power enable signal, the slice 212D powers down. As such, the power drawn by the MMA 206 steps down from about 8,000 mW to about 6,000 mW.

In the illustrated example of FIG. 3, at time t₈, the analytics power management circuit 204 places the MMA 206 in an eighth example stage 316. For example, in the eighth stage 316, the analytics power management circuit 204 de-asserts the power enable signal for the slice 212C. In some examples, the analytics power management circuit 204 also de-asserts the clock enable signal for the slice 212C. Responsive to the de-asserted power enable signal, the slice 212C powers down. As such, the power drawn by the MMA 206 steps down from about 6,000 mW to about 4,300 mW. In the example of FIG. 3, the period between time t₇ and time to is a programmable value.

In the illustrated example of FIG. 3, at time to, the analytics power management circuit 204 places the MMA 206 in a ninth example stage 318. For example, in the ninth stage 318, the analytics power management circuit 204 de-asserts the power enable signal for the slice 212B. In some examples, the analytics power management circuit 204 also de-asserts the clock enable signal for the slice 212B. Responsive to the de-asserted power enable signal, the slice 212B powers down. As such, the power drawn by the MMA 206 steps down from about 4,300 mW to about 2,500 mW. In the example of FIG. 3, the period between time t₈ and time t₉ is a programmable value.

In the illustrated example of FIG. 3, at time t₁₀, the analytics power management circuit 204 places the MMA 206 in a tenth example stage 320. For example, in the tenth stage 320, the analytics power management circuit 204 de-asserts the power enable signals for the core circuit 210 and the slice 212A. In some examples, the analytics power management circuit 204 also de-asserts the clock enable signals for the core circuit 210 and the slice 212A. Responsive to the de-asserted power enable signals, the core circuit 210 and the slice 212A power down. As such, the power drawn by the MMA 206 steps down from about 2,500 mW to 0 mW. In the example of FIG. 3, the period between time to and time t₁₀ is a programmable value. After time t₁₀, the MMA 206 is off or in the reset state. As such, the stages 314-320 correspond to the shutdown state of the MMA 206.

In the illustrated example of FIG. 3, the change in power drawn by the MMA 206 between consecutive stages of the multi-stage startup procedure and the multi-stage shutdown procedure as well as the duration of each stage determines the current drawn by the MMA 206 over time (e.g., di/dt). Advantageously, the number of stages of the multi-stage startup procedure, the number of stages of the multi-stage shutdown procedure, and the duration of each stage are programmable. For example, the registers 208 of FIG. 2 can be programmed to specify the number of stages of the multi-stage startup procedure, the number of stages of the multi-stage shutdown procedure, and the duration of each stage.

During operation, the analytics power management circuit 204 can access a power management control signal (identified as alm_pwr_mgr ctrl in FIG. 2) that specifies the number of stages of the multi-stage startup procedure, the number of stages of the multi-stage shutdown procedure, and the duration of each stage. In the example of FIG. 3, the number of stages of the multi-stage startup procedure and the multi-stage shutdown procedure is four. Additionally, in the example of FIG. 3, the programmable period between consecutive stages of the multi-stage startup procedure and consecutive stages of the multi-stage shutdown procedure is set to at least 0.25 microseconds (μs). For example, a stage duration of 0.25 μs corresponds to reduced noise in the supply voltage to the MMA 206.

As illustrated in FIG. 3, the MMA 206 can return to the active state (e.g., the fifth stage 310) during any of the stages of the multi-stage shutdown procedure. For example, if the DSP 202 provides an alert signal to the analytics power management circuit 204 to indicate that an instruction for the MMA 206 has entered the pipeline of the DSP 202, the analytics power management circuit 204 can initiate the startup procedure for the MMA 206 (e.g., similar to one or more of the stages 302-308). If the MMA 206 is to return to the active state, the analytics power management circuit 204 asserts the stall signal until the MMA 206 has completed the startup procedure.

Returning to FIG. 2, the analytics power management circuit 204 can power up or power down the MMA 206 depending on whether a matrix multiplication operation has been offloaded to the MMA 206 as described above. As such, in addition to not consuming any dynamic power, powered down portions of the MMA 206 do not consume leakage power. In some examples, after the MMA 206 is powered up, the analytics power management circuit 204 can perform clock gating instead of powering down portions of the MMA 206. For example, once the MMA 206 is idle, the analytics power management circuit 204 can keep the power enable signals for the core circuit 210 and each of the slices 212A-212D asserted and de-assert the clock enable signals for one or more of the core circuit 210 or the slices 212A-212D.

As such, the dynamic power consumption of the MMA 206 will be reduced and the respective portions of the MMA 206 can be enabled or disabled in a single clock cycle. Depending on the application, a user of the analytics worker 200 may elect to utilize power gating or clock gating. For example, in low latency applications demanding quick matrix multiplications, a user may elect to utilize clock gating as power gating requires more clock cycles to enable the MMA 206 than clock gating. Conversely, in a power constrained application, a user may elect to utilize power gating as power gating conserves more power than clock gating.

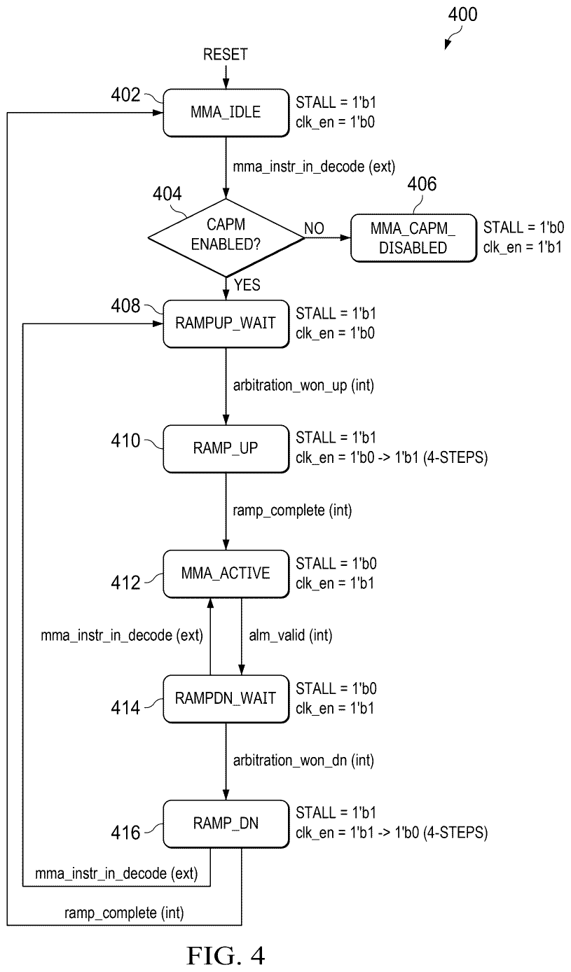

FIG. 4 is an illustration of an example state machine 400 that may be utilized by the analytics power management circuit 204 of FIG. 2 to control power supplied to the MMA 206 of FIG. 2. Although this disclosure describes the example of MMA 206, the techniques of this disclosure can be implemented for other types of processor circuits such as vision processing circuits, audio processing circuits, FFT processing circuits, cryptographic processing circuits, and the like. The example state machine 400 includes an idle power state 402 for an MMA (e.g., the MMA 206). The idle power state 402 is the state which is returned-to when a reset occurs. In the idle power state 402, a relatively low power may be supplied (e.g., 0 watts, 100 milliwatts, etc.). The analytics power management circuit 204 commands the idle power state 402 when the corresponding MMA 206 is in the idle operating state. From the idle power state 402, the analytics power management circuit 204 may determine that the MMA 206 has been commanded to perform an instruction. The analytics power management circuit 204 determines if cluster analytics power management is enabled at block 404. If cluster analytics power management is not enabled, the analytics power management circuit 204 moves to a power management disabled state 406. For example, in the power management disabled state 406, power to the MMA 206 may simply move from the idle power state 402 to a full power state for the MMA 206. In other words, power management may not be applied or fully applied to manage power transitions.

When cluster analytics power management is enabled (block 404), the analytics power management circuit 204 enters a power ramp up waiting state 408 to await the start of power ramp up. For example, in a system that includes multiple MMA, the analytics power management circuit 204 may wait to ramp up power for one MMA when another MMA is ramping up to avoid simultaneous ramping up power to multiple MMAs. After the analytics power management circuit 204 arbitrates the initiation of ramping up power and determines that the current MMA is to ramp up, the analytics power management circuit 204 enters a ramping up state during which the power to the MMA 206 is stepped up by a defined (e.g., user defined) step size (e.g., 2 watts per step). Once the ramp up of power has completed, the analytics power management circuit 204 transitions to an active power state 412. For example, the active power state may be a full power state for the MMA (e.g., 10 watts).

The analytics power management circuit 204 can prevent a huge in-rush current to the MMA 206 by ramping up sequentially or granularly, rather than ramping up all at once. An all-at-once ramp up can create a large in-rush current that can potentially overwhelm a power supply, resulting in an undesirable power droop. The power supply can be designed to handle this large in-rush current, but such a design will be more expensive, consume more chip area, and require additional heat dissipation resources as compared to a power supply designed for the sequential ramp up shown in FIG. 3. As a result, the techniques of this disclosure can lower the cost and reduce the chip area required for a power supply.

While in the active power state 412, if the MMA 206 transitions to an idle operating state (e.g., no instructions are scheduled for execution), the analytics power management circuit 204 transitions to a ramp down wait state 414. In the ramp down wait state 414, the analytics power management circuit 204 is waiting to ensure that a new instruction for execution is not received (e.g., to prevent ramping down too quickly). If a new instruction for execution is received before a wait time expires, the analytics power management circuit transitions back to the active power state 412.

While the analytics power management circuit 204 is in the ramp down wait state 414, when a wait time expires, the analytics power management circuit 204 transitions to a ramping down power state 416. In the ramp down power state 416, the analytics power management circuit 204 starts stepping down power to the MMA 206 by a defined (e.g., user defined) step size (e.g., 2 watts per step). While in the ramping down power state 416, before the power is stepped down to the idle power state 402, if a new instruction for execution by the MMA is received, the analytics power management circuit 204 transitions back to the ramp up wait state 408 to re-start the process of ramping power back up towards the active power state 412. Alternatively, if no new instructions are received, the analytics power management circuit 204 will eventually have stepped power back down to the idle power state 402.

Accordingly, in operation of the state machine 400 of FIG. 4, when in an idle state and new work is received for the MMA, the analytics power management circuit 204 will start stepping up power until a full power state is reached. While in the full power state, if the MMA becomes idle, the analytics powers management circuit 204 will start stepping down power until a new instruction is received (at which point power is stepped back up towards the active state) or the idle state is reached. While the example analytics power management circuit 204 ramps up power until the active power state 412 is reached, in some examples, the analytics power management circuit 204 may determine that an MMA has transitioned to an idle operating state while the power is being ramped up (e.g., while in the ramp up power state 410) and the analytics power management circuit 204 may then transition to the ramp down wait power state 414 to initiate the transition back towards the idle power state 402.

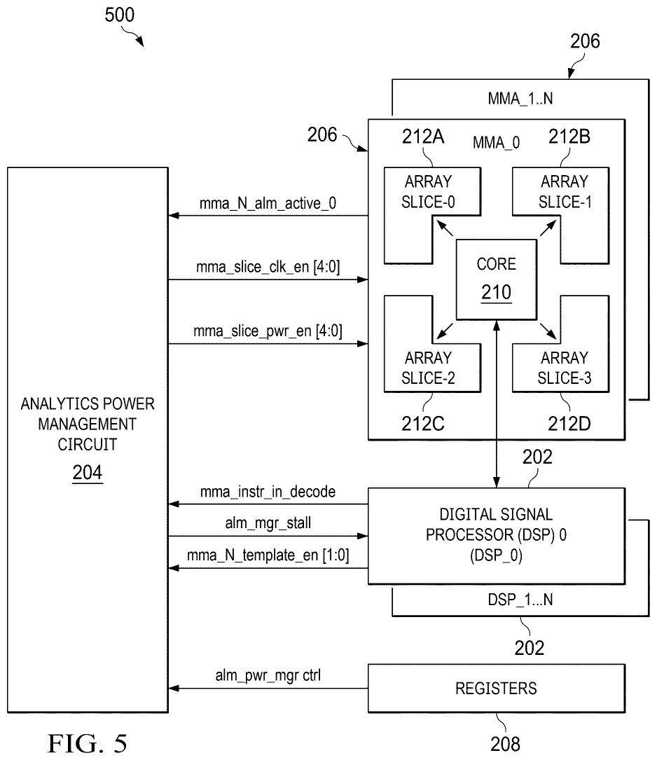

FIG. 5 is a block diagram of an example analytics cluster 500 that can implement the analytics cluster 104 of FIG. 1. The example of FIG. 5 illustrates the analytics power management circuit 204 controlling power for a plurality of MMA 206. For example, the plurality of MMA 206 may each include a plurality of array slides 212 and the analytics power management circuit 204 may be configurable to step up and down power to each of the MMA 206 and/or each of the array slices 212 (e.g., four slices and a core).

In some examples, the analytics power management circuit 204 can provide improved power control for a cluster of MMA by not only providing step up and down power that avoids rapid current changes, but the analytics power management circuit 204 can control the step up and down of reach of the MMA to avoid performing multiple power steps across the MMA simultaneously. In addition, the analytics power management circuit 204 can determine a number of steps and/or step size based on the number of MMA that are to be ramped up. For example, a system that has four MMA will have a power supply sufficient to power the four MMA, so if only one of the MMA needs to be transitioned from idle power state to active power state, the analytics power management circuit 204 may determine to step power up in a single step (rather than 4 steps) because the power supply can source sufficient power during the ramp up to prevent a droop.

When multiple MMA are included, dynamic power may dominate over leakage power such that clock may be utilized with each slice of the MMAs instead of fully turning of power. Such clock gating may aid in supporting faster transition times between states as compared with power supply control.

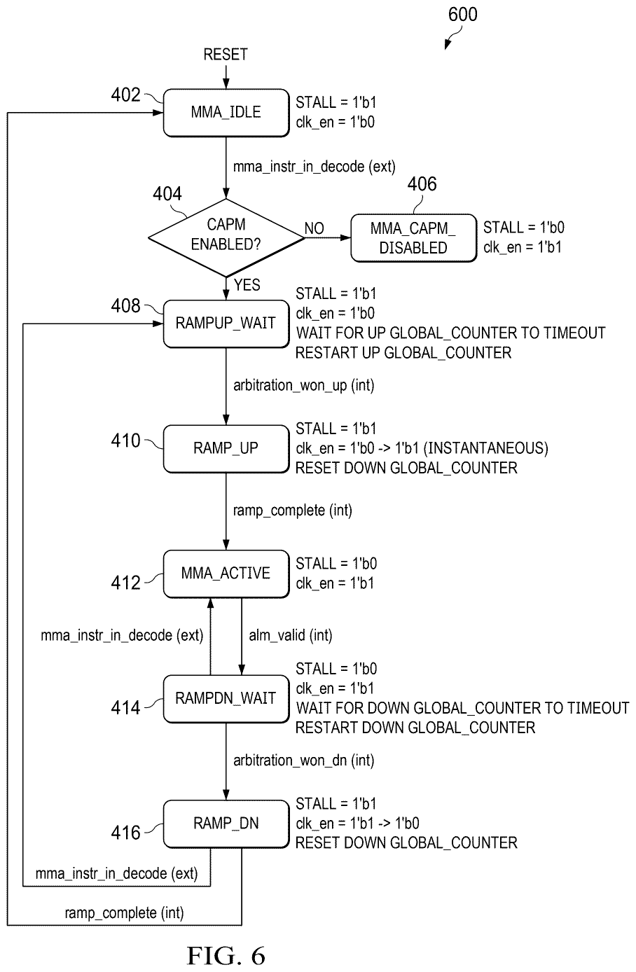

FIG. 6 is an illustration of an example state machine 600 that may be utilized by the analytics power management circuit 204 of FIG. 5 to control power supplied to the MMA 206 of FIG. 5. The state machine 600 of FIG. 6 includes the same states as FIG. 4 and the states are labeled with the same reference numbers. However, the operation of the example state machine 600 includes an example up global counter and an example down global counter to facilitate power control when controlling operation of a plurality of MMA. In the example ramp up wait state 408 of FIG. 5, the analytics power management circuit 204 proceeds to instantaneously transition to the ram up state 410 after a global counter times out to ensure that two or more MMA are not stepping up simultaneously in the same direction (e.g., ramping up or ramping down) (e.g., one may ramp up while another is ramping down). Once the up global counter times out, the analytics power management circuit 204 transitions to the ramp up state 410 and restarts the up global counter.

In the ramping up state 410, the analytics power management circuit 204 resets the up global counter while operating to ensure that another MMA does not enter the ramp up state until this ramp up is completed.

In the ramp down wait state 414, the analytics power management circuit 204 waits for the down global counter to timeout before proceeding to the ramp down state 416 and resetting the down global counter.

In the ramping down state 416, the analytics power management circuit 204 resets the down global counter to ensure that another MMA does not enter the ramp down state until this ramp down is completed.

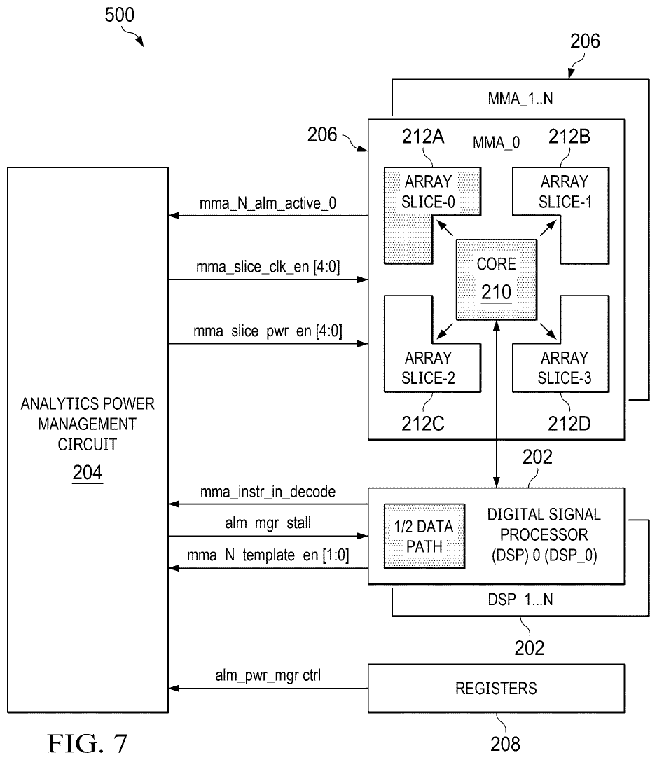

FIG. 7 is a block diagram of the analytics cluster 500 of FIG. 5 depicting an example use case when the size of matrices for a matrix multiplication operation will not fully occupy one of the MMAs 206 of FIG. 5. For example, as described above, each of the MMAs 206 is configurable to multiply two 128 by 128 element matrixes and to produce a 128 by 128 element matrix as a result. In some deep learning use cases, many layers of an AI/ML model cannot fully utilize the full 128 by 128 element hardware array of the MMAs 206. When one of the MMAs 206 is underutilized (e.g., not fully occupied), the corresponding one of the MMAs 206 wastes power (e.g., due to active hardware not performing any matrix multiplication operation).

Advantageously, the slice-based architecture of the MMAs 206 allows the DSPs 202 and the analytics power management circuit 204 to operate the MMAs 206 in a slice mode. In the slice mode, the DSPs 202 and the analytics power management circuit 204 selectively enable one or more slices of corresponding ones of the MMAs 206. For example, depending on the size of data to be processed by the first MMA 206 (identified as MMA_0), the first DSP 202 (identified as DSP_0) can determine a number of slices of the MMA 206 to enable and provide a slice number notification to the analytics power management circuit 204 indicating that number of slices. Responsive to identifying the number of slices, the analytics power management circuit 204 enables the corresponding ones of the slices 212A-212D and the core circuit 210. While the slice mode of operation is described with respect to the analytics cluster 500 of FIG. 5, the slice mode of operation is also applicable to the analytics worker 200 of FIG. 2.

In the illustrated example of FIG. 7, the first DSP 202 determines a number of slices of the first MMA 206 to enable by comparing the number of clock cycles required to perform the matrix multiplication operation in various configurations. For example, the supported configurations of the first MMA 206 in slice mode include the core circuit 210 and N slices where N is one slice, two slices, or the full 128 by 128 element hardware array of the first MMA 206 (e.g., N=1, 2, or 4). In the example of FIG. 7, the first DSP 202 selects whichever of the configurations requires the lowest number of clock cycles. If two configurations require the same number of clock cycles, the first DSP 202 selects the configuration corresponding to the least number of enabled slices.

When configured for one slice operation, the first DSP 202 and the analytics power management circuit 204 enable the core circuit 210 and the slice 212A. In the one slice configuration, the slice 212A has equivalent performance to a 64 by 64 element MMA and can perform 12 TOPS when operating at 1.5 GHZ. Table 2 illustrates a comparison between the performance of the full 128 by 128 element hardware array of the first MMA 206 and a one slice configuration of the first MMA 206 (e.g., the core circuit 210 and the slice 212A).

TABLE 2

| | Predicted Clock Cycles | | Slice-based MMA | |
|---|---|---|---|---|
| | Full | Single | Selected | Clock |
| Network Layer | Array | Slice | Configuration | cycles |
| Layer 1 | 1,000 | 1,000 | 64 × 64 | 1,000 |
| Layer 2 | 1,000 | 3,500 | 128 × 128 | 1,000 |
| DSP Layer | 1,000 | 1,000 | No MMA | 1,000 |
| Layer N | 1,000 | 1,000 | 64 × 64 | 1,000 |
| Total Cycles | 4,000 | 6,500 | | 4,000 |
| % Perf. W.R.T. | 1.00 | 0.62 | | 1.00 |
| Full Array | | | | |
| % Power W.R.T. | 1.00 | 0.55 | | 0.45 |
| Full Array | | | | |

As illustrated in Table 2, the one slice configuration of the first MMA 206 has equivalent performance to the full four slice configuration of the first MMA 206 when matrix sizes fit the 64 by 64 element size of the slice 212A but consumes roughly ⅖^{th} the power that the full four slice configuration of the first MMA 206 consumes. As such, by selectively enabling one or more slices of the first MMA 206, the first DSP 202 and the analytics power management circuit 204 can achieve the same performance as the full 128 by 128 element hardware array of the first MMA 206 with a fraction of the active power consumption.

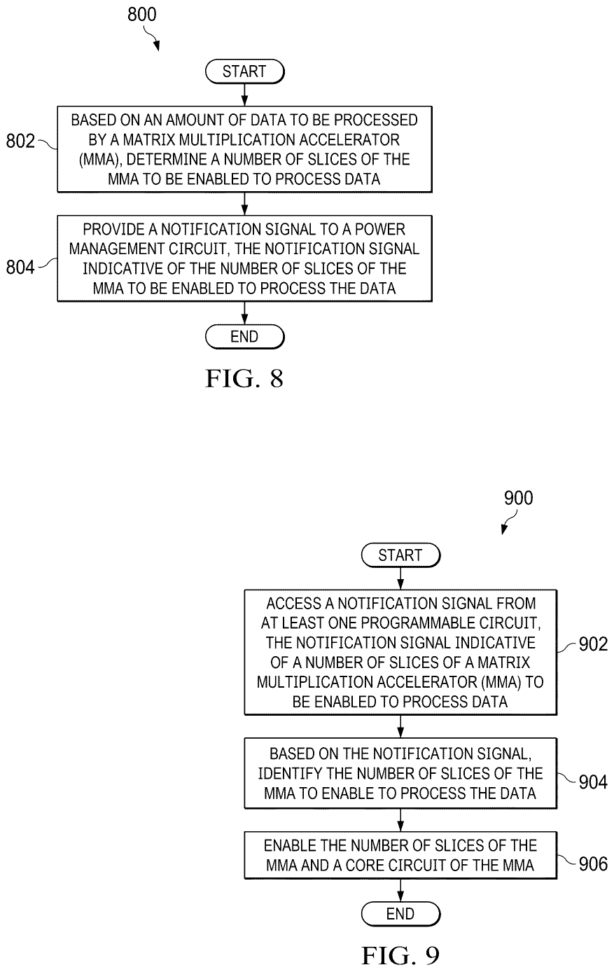

FIG. 8 is a flowchart representative of example machine-readable instructions or example operations 800 that may be at least one of executed, instantiated, or performed using an example programmable circuitry implementation of the DSPs 202 of FIGS. 2 and/or 5 to determine how many slices of one or more of the MMAs 206 of FIGS. 2 and/or 5 for a matrix multiplication operation. The example machine-readable instructions and/or the example operations 800 of FIG. 8 begin at block 802, at which the DSP 202, based on an amount of data to be processed by the MMA 206, determines a number of slices of the MMA 206 to be enabled to process the data. At block 804, the DSP 202 provides a notification signal to the analytics power management circuit 204. For example, the notification signal indicates the number of slices of the MMA 206 to be enabled to process the data.

FIG. 9 is a flowchart representative of example machine-readable instructions or example operations 900 that may be at least one of executed, instantiated, or performed using an example programmable circuitry implementation of the analytics power management circuits 204 of FIGS. 2 and/or 5 to enable one or more of the MMAs 206 of FIGS. 2 and/or 5 for a matrix multiplication operation. The example machine-readable instructions and/or the example operations 900 of FIG. 9 begin at block 902, at which analytics power management circuit 204 accesses a notification signal from at least one programmable circuit. For example, the at least one programmable circuit is the DSP 202 and the notification signal is indicative of a number of slices of the MMA 206 to be enabled to process data.

In the illustrated example of FIG. 9, at block 904, based on the notification signal, the analytics power management circuit 204 identifies the number of slices of the MMA 206 to enable to process the data. In the example of FIG. 9, at block 906, the analytics power management circuit 204 enables the number of slices of the MMA 206 and the core circuit 210 of the MMA 206. For example, the analytics power management circuit 204 enables the number of slices of the MMA 206 and the core circuit 210 of the MMA 206 via clock gating or power gating as described above.

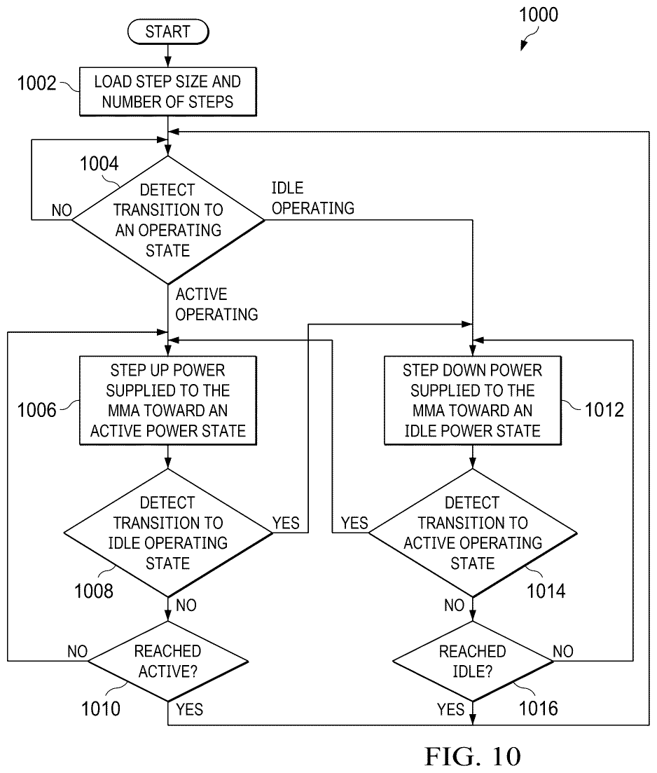

FIG. 10 is a flowchart representative of example machine-readable instructions or example operations that may be at least one of executed, instantiated, or performed using an example programmable circuitry implementation of the analytics power management circuits of FIGS. 2 and/or 5 to manage power consumption by one or more of the MMAs of FIGS. 2 and/or 5.

The example machine-readable instructions and/or the example operations 1000 of FIG. 10 begin at block 1002, at which the analytics power management circuit 204 loads step size and number of step settings. For example, a user may specify a number of steps and a step duration to be used when ramping up or ramping down power supply to the MMA 206 (e.g., 4 steps at 0.25 microseconds each). The settings may be stored in a register, a file, etc. According to the illustrated example, the settings are loaded during an initial power on of the analytics power management circuit 204, but the settings could alternatively be loaded at any later time (e.g., when a user inputs new settings). While number of steps and step duration are provided as examples other user settings may be utilized such as a step size, a minimum power threshold, a maximum power threshold, a slope or time duration to be utilized to ramp up from one ramp to another, a duration of time to wait before determining an idle operating state and/or an active operating state, etc. Any combination of the settings may be utilized to determine the protocol for ramping up.

The analytics power management circuit 204 then begins to detect a transition of the MMA 206 to a new operating state (block 1004). For example, the MMA 206 may transition from an idle operating state to an active operating state or may transition from an active operating state to an idle operating state.

When the analytics power management circuit 204 detects that the MMA 206 has transitioned to the active operating state (e.g., when a new instruction for execution by the MMA 206 is received, scheduled, executed, etc.), the analytics power management circuit 204 begins to step up power supplied to the MMA 206 toward an active power state (block 1006). The step size and number of steps to reach the active power state are set by the settings loaded in block 1002. After each step of ramping up power, the analytics power management circuit 204 determines if the MMA 206 has transitioned from the active operating state to the idle operating state (block 1008). If the MMA 206 has transitioned to the idle operating state, control proceeds to block 1012 to start stepping power back down. Alternatively, in some examples, once the analytics power management circuit 204 has started ramping up power, it will not transition back to ramping down until it has reached the active power state.

When the analytics power management circuit 204 determines that the MMA 206 has not transitioned to the idle operating state (block 1008), the analytics power management circuit 204 determines if the ramping up has reached the active power state (block 1010). For example, the analytics power management circuit 204 may determine if a threshold power level (e.g., 10 watts) has been reached. When the active power state has not been reached, control returns to block 1006 to ramp up the next step. When the active power state has been reached, control returns to block 1004 to begin monitoring for a transition to the idle operating state.

Returning back to block 1004, when the analytics power management circuit 204 determines that the MMA 206 has transitioned to the idle operating state (from block 1004 or block 1008), the analytics power management circuit 204 begins stepping down power supplied to the MMA 206 toward an idle power state (block 1012). The step size and number of steps to reach the active power state are set by the settings loaded in block 1002. After each step of ramping down power, the analytics power management circuit 204 determines if the MMA 206 has transitioned from the idle operating state to the active operating state (block 1014). If the MMA 206 has transitioned to the active operating state, control proceeds to block 1006 to start stepping power back up towards the active power state. Alternatively, in some examples, once the analytics power management circuit 204 has started ramping down power, it will not transition back to ramping up until it has reached the idle power state.

When the analytics power management circuit 204 determines that the MMA 206 has not transitioned to the active operating state (block 1014), the analytics power management circuit 204 determines if the ramping down has reached the idle power state (block 1016). For example, the analytics power management circuit 204 may determine if a threshold power level (e.g., 0 watts, 0.10 watts, etc.) has been reached. When the idle power state has not been reached, control returns to block 1012 to ramp down the next step. When the idle power state has been reached, control returns to block 1004 to begin monitoring for a transition to the active operating state.

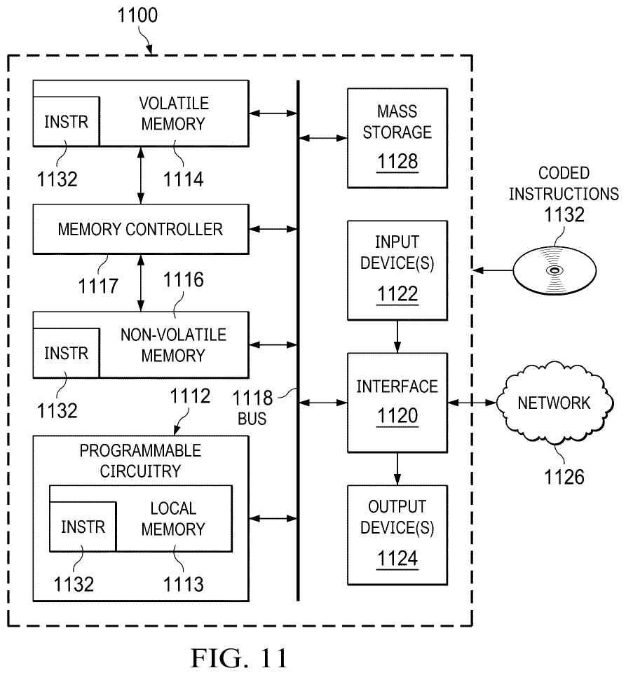

FIG. 11 is a block diagram of an example programmable circuitry platform 1100 structured to one or a combination of execute or instantiate one or more of the example machine-readable instructions or the example operations of FIGS. 8-10 to implement the analytics power management circuit 204 of FIG. 2, FIG. 5, and/or FIG. 7. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, or microcontrollers from any desired family or manufacturer. The programmable circuitry 1112 may be implemented by one or more semiconductor based (e.g., silicon based) devices. In this example, the programmable circuitry 1112 implements the analytics power management circuit 204.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1116 may be implemented by one or a combination of flash memory or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter one of or a combination of data or commands into the programmable circuitry 1112. The input device(s) 1122 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1124 are also connected to the interface circuitry 1120 of the illustrated example. The output device(s) 1124 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1120 of the illustrated example, thus, includes one of or a combination of a graphics driver card, a graphics driver chip, or graphics processor circuitry such as a GPU.

The interface circuitry 1120 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store one or more of firmware, software, or data. Examples of such mass storage discs or devices 1128 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 1132, which may be implemented by the machine-readable instructions of FIGS. 8-10, may be stored in one of or a combination of the mass storage device 1128, in the volatile memory 1114, in the non-volatile memory 1116, or on at least one non-transitory computer-readable storage medium such as a CD or DVD which may be removable.

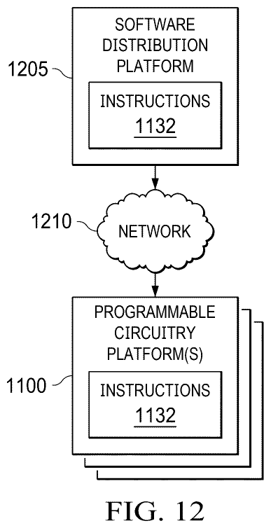

A block diagram illustrating an example software distribution platform 1205 to distribute software such as the example machine-readable instructions 1132 of FIG. 11 to other hardware devices (e.g., one or more hardware devices owned or operated by third parties from the owner or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity at least one of owning or operating the software distribution platform 1205. For example, the entity that at least one of owns or operates the software distribution platform 1205 may be at least one of a developer, a seller, or a licensor of software such as the example machine-readable instructions 1132 of FIG. 11. The third parties may be consumers, users, retailers, OEMs, etc., who one of or a combination of purchase or license the software for at least one of use, re-sale, or sub-licensing. In the illustrated example, the software distribution platform 1205 includes one or more servers and one or more storage devices. The storage devices store the machine-readable instructions 1132, which may correspond to the example machine-readable instructions of FIGS. 8-10, as described above. The one or more servers of the example software distribution platform 1205 are in communication with an example network 1210, which may correspond to any one or more of the Internet or any of the example networks described above. In some examples, the one or more servers are responsive to requests to transmit the software to a requesting party as part of a commercial transaction. Payment for at least one of the delivery, sale, or license of the software may be handled by the one or more servers of at least one of the software distribution platform or by a third party payment entity. The servers enable one or more purchasers or licensors to download the machine-readable instructions 1132 from the software distribution platform 1205. For example, the software, which may correspond to the example machine-readable instructions of FIG. 8-10, may be downloaded to the example programmable circuitry platform 1100, which is to execute the machine-readable instructions 1132 to implement the DSP 202 and/or the analytics power management circuit 204. In some examples, one or more servers of the software distribution platform 1205 periodically at least one of offer, transmit, or force updates to the software (e.g., the example machine-readable instructions 1132 of FIG. 11) to ensure improvements, patches, updates, etc., are distributed and applied to the software at the end user devices. Although referred to as software above, the distributed “software” could alternatively be firmware.

While an example manner of implementing the analytics power management circuit 204 of FIG. 1 is illustrated in FIG. 2, FIG. 5, and/or FIG. 7, one or more of the elements, processes, or devices illustrated in FIG. 2, FIG. 5, and/or FIG. 7 may be combined, divided, re-arranged, omitted, eliminated, or implemented in any other way. Further, the example analytics power management circuit 204 of FIG. 2, FIG. 5, and/or FIG. 7, may be implemented by hardware alone or by hardware in combination with software and firmware. Thus, for example, any of the analytics power management circuit 204, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), DSP(s), ASIC(s), programmable logic device(s) (PLD(s)), or field programmable logic device(s) (FPLD(s)) such as FPGAs. Further still, the example analytics power management circuit 204 of FIG. 2, FIG. 5, and/or FIG. 7 may include one or more elements, processes, or devices in addition to, or instead of, those illustrated in FIG. 2, FIG. 5, and/or FIG. 7, or may include more than one of any or all of the illustrated elements, processes and devices.

Flowchart(s) representative of example machine-readable instructions, which may be executed by programmable circuitry to at least one of implement or instantiate the analytics power management circuit 204 of FIG. 2, FIG. 5, and/or FIG. 7 or representative of example operations which may be performed by programmable circuitry to at least one of implement or instantiate the analytics power management circuit 204 of FIG. 2, FIG. 5, and/or FIG. 7, are shown in FIGS. 8-10. The machine-readable instructions may be one or more executable programs or portion(s) of one or more executable programs for execution by programmable circuitry such as the programmable circuitry 1112 shown in the example processor platform 1100 discussed below in connection with FIG. 11 and may be one or more function(s) or portion(s) of functions to be performed by the example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., software and/or firmware) stored on one or more non-transitory computer-readable and/or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer-readable and/or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 8-10, many other methods of implementing the example analytics power management circuit 204 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, one of or a combination of a CPU or an FPGA. The programmable circuitry may include one or more CPUs and/or one or more FPGAs located in the same package (e.g., the same integrated circuit (IC) package or in two or more separate housings), one or more CPUs or FPGAs in a single machine, one or multiple CPUs or FPGAs distributed across multiple servers of a server rack, multiple processors distributed across one or more server racks. Also or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine-executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine-executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer-readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 8-10 may be implemented using executable instructions (e.g., computer-readable and/or machine-readable instructions) stored on one or more non-transitory computer-readable or machine-readable media. As used herein, the terms non-transitory computer-readable medium, non-transitory computer-readable storage medium, non-transitory machine-readable medium, and non-transitory machine-readable storage medium are expressly defined to include any type of computer-readable storage device or storage disk and to exclude propagating signals and to exclude transmission media. Examples of such non-transitory computer-readable medium, non-transitory computer-readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer-readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer-readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer-readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” may be understood to include (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, DSPs that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry may be understood as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

Modifications are possible in the described embodiments, and other embodiments are possible, within the scope of the claims.

From the foregoing, it will be appreciated that example systems, apparatus, articles of manufacture, and methods have been described that control power to a target circuit such as a matrix multiplication accelerator. Described systems, apparatus, articles of manufacture, and methods facilitate power control to a device by stepping/ramping up and down the power to prevent large, rapid changes in power that may lead to droop or increased power supply requirements. Furthermore, in some examples, a target circuit (e.g., a matrix multiplication accelerator) may be split into multiple power domains where power can be controlled separately to each slice, which can further reduce large swings in power usage by ramping up power to the circuit by increasing power to the slices one at a time.

Additionally, the slice-based architecture permits power to be selectively enabled to one or more slices at a time depending on the amount of data to be processed by the target circuit. By selectively enabling one or more slices of a target circuit, example described herein can achieve the same performance as a monolithic circuit (e.g., with a non-slice-based architecture) with a fraction of the active power consumption. Described systems, apparatus, articles of manufacture, and methods are also directed to one or more improvement(s) in the operation of a machine such as a computer or other electronic, electromechanical, or mechanical device.

The analytics power management circuitry disclosed herein may be utilized with any type of system in which power control for managing state changes is desirable. For example, automative applications like cameras, radar, lidar, etc.; industrial control applications, robotics, real-time systems, embedded systems, and other applications can benefit from the managed ramp up and/or ramp down in power to reduce issues caused by fast current flow changes that affect the ability of a power supply to maintain a consistent power level, cause additional power consumption, cause in-rush current, create increased heat, etc. While examples are discussed as controlling matrix multiplication accelerators, the disclosed approaches may be utilized with any type of target circuit including any other type of accelerator.

Example methods, apparatus, systems, and articles of manufacture for power management for processor circuits are disclosed herein. Further examples and combinations thereof include the following:

Example 1 includes a device comprising interface circuitry, and at least one programmable circuit coupled to the interface circuitry and configurable to determine, based on an amount of data to be processed, a number of slices of a processor circuit to enable to process the data, and enable the number of slices of the processor circuit to process the data.

Example 2 includes the device of example 1, wherein the processor circuit is a matrix multiplication accelerator.

Example 3 includes the apparatus of any one or more of examples 1-2, wherein one or more of the at least one programmable circuit is configurable to enable the number of slices and a core circuit of the processor circuit while remaining slices remain disabled.

Example 4 includes the apparatus of any one or more of examples 1-3, wherein one or more of the at least one programmable circuit is configurable to, responsive to detecting an idle state of the processor circuit, disable the number of slices of the processor circuit.

Example 5 includes the apparatus of any one or more of examples 1-4, wherein one or more of the at least one programmable circuit is configurable to detect an idle state of the processor circuit responsive to the processor circuit processing synthetic data for a threshold period.

Example 6 includes the apparatus of any one or more of examples 1-5, wherein the number of slices includes two, and one or more of the at least one programmable circuit is configurable to at a first time, provide a first clock enable signal to a first slice of the processor circuit, and at a second time after the first time, provide a second clock enable signal to a second slice of the processor circuit.

Example 7 includes the device of example 6, wherein the second time is at least 0.25 microseconds after the first time.

Example 8 includes the apparatus of any one or more of examples 6-7, wherein one or more of the at least one programmable circuit is configurable to provide a third clock enable signal to a core circuit of the processor circuit at the first time.

Example 9 includes the apparatus of any one or more of examples 1-8, wherein the number of slices includes two, and one or more of the at least one programmable circuit is configurable to at a first time, provide a first power enable signal to a first slice of the processor circuit, and at a second time after the first time, provide a second power enable signal to a second slice of the processor circuit.

Example 10 includes the device of example 9, wherein the second time is at least 0.25 microseconds after the first time.

Example 11 includes the apparatus of any one or more of examples 9-10, wherein one or more of the at least one programmable circuit is configurable to provide a third power enable signal to a core circuit of the processor circuit at the first time

Example 12 includes a system comprising a processor circuit having at least two slices, at least one programmable circuit coupled to the processor circuit and configurable to determine, based on an amount of data to be processed, a number of slices of the processor circuit to enable to process the data, and a power management circuit coupled to the processor circuit and coupled to the at least one programmable circuit, the power management circuit configurable to identify the number of slices of the processor circuit to enable to process data based on an indication from the at least one programmable circuit, and enable the number of slices to process the data, and wherein the at least one programmable circuit is configurable to provide the data to the processor circuit.

Example 13 includes the system of example 12, wherein the processor circuit is a matrix multiplication accelerator.

Example 14 includes the apparatus of any one or more of examples 12-13, wherein one or more of the at least one programmable circuit is configurable to provide the data to the processor circuit after the number of slices are enabled.

Example 15 includes the apparatus of any one or more of examples 12-14, wherein the processor circuit further includes a core circuit, and wherein the power management circuit is configurable to enable the number of slices and the core circuit to process the data while remaining slices remain disabled.

Example 16 includes the apparatus of any one or more of examples 12-15, wherein a first slice of the processor circuit includes a first multiplication circuit in a first power domain, wherein a second slice of the processor circuit includes a second multiplication circuit separate from the first multiplication circuit, and wherein the second slice is in a second power domain separate from the first power domain.

Example 17 includes the apparatus of any one or more of examples 12-16, wherein the processor circuit, the power management circuit, and the at least one programmable circuit are implemented on different dies within a same package.

Example 18 includes the apparatus of any one or more of examples 12-17, wherein the power management circuit is configurable to, responsive to detecting an idle state of the processor circuit, disable the number of slices of the processor circuit.

Example 19 includes the apparatus of any one or more of examples 12-18, wherein the data is first data, the processor circuit is configurable to process synthetic data when the at least one programmable circuit has not provided second data to process, and the power management circuit is configurable to detect an idle state of the processor circuit responsive to the processor circuit processing the synthetic data for a threshold period.

Example 20 includes the system of example 15, wherein to identify the number of slices, the power management circuit is configurable to identify two slices to enable to process the data, and wherein the power management circuit is configurable to at a first time, provide a first clock enable signal to a first slice of the processor circuit and a second clock enable signal to the core circuit, and at a second time after the first time, provide a third clock enable signal to a second slice of the processor circuit.

Example 21 includes the apparatus of any one or more of examples 15-20, wherein to identify the number of slices, the power management circuit is configurable to identify two slices to enable to process the data, and wherein one or more of the power management circuit is configurable to at a first time, provide a first power enable signal to a first slice of the processor circuit and a second power enable signal to the core circuit, and at a second time after the first time, provide a third power enable signal to a second slice of the processor circuit.

Example 22 includes the system of example 21, wherein the power management circuit is configurable to, responsive to an alert signal indicating that the at least one programmable circuit has requested processing of the data, provide a stall signal to the at least one programmable circuit, the stall signal to delay the at least one programmable circuit from providing the data to the processor circuit until the number of slices of the processor circuit is enabled.

Example 23 includes a processor circuit comprising a first slice configurable to be selectively enabled responsive to a first signal from a power management circuit, a second slice configurable to be selectively enabled responsive to a second signal from the power management circuit, and a core circuit configurable to be enabled coincidentally with the first slice.

Example 24 includes the processor circuit of example 23, wherein the processor circuit is a matrix multiplication accelerator.

Example 25 includes a device comprising a first processor circuit, and power management circuit coupled to the first processor circuit and configurable to detect an idle operating state of the first processor circuit while the power management circuit is in an active power state, initiate stepping down power to the first processor circuit towards an idle power state in response to detecting the idle operating state, and transition the power to the first processor circuit to the active power state in response to detection of a transition of the first processor circuit to an active operating state before the power management circuit has stepped power down to the idle power state.

Example 26 includes the device of example 25, wherein the first processor circuit includes a first slice and a second slice, wherein the power management circuit is configurable to step down power to the first processor circuit towards the idle power state by deactivating the first slice while supplying power to the second slice.

Example 27 includes the device of example 26, wherein the power management circuit is configurable to transition the power to the first processor circuit to the active power state by activating the first slice while supplying power to the second slice.

Example 28 includes the apparatus of any one or more of examples 25-27, wherein the power management circuit is configurable to detect the idle operating state by detecting that the first processor circuit is not processing data.

Example 29 includes the apparatus of any one or more of examples 25-28, wherein the power management circuit is configurable to step the power to the first processor circuit through at least two steps between the active power state and the idle power state.

Example 30 includes the apparatus of any one or more of examples 25-29, wherein the power management circuit is configurable to step power to the first processor circuit through at least two steps up while returning to the active power state after starting to step power down.

Example 31 includes the apparatus of any one or more of examples 25-30, wherein the power management circuit is configurable to control a power state of the first processor circuit by controlling a power supplied to the first processor circuit.

Example 32 includes the apparatus of any one or more of examples 25-31, wherein the power management circuit is configurable to control a power state of the first processor circuit by controlling a clock for the first processor circuit.

Example 33 includes the apparatus of any one or more of examples 25-32, wherein the device includes a second processor circuit, and wherein the power management circuit is configurable to control a first power state of the first processor circuit and a second power state of the second processor circuit.

Example 34 includes the apparatus of any one or more of examples 25-33, wherein the first processor circuit includes a first power domain and a second power domain.

Example 35 includes the apparatus of any one or more of examples 25-34, further including a register to store a step size for the stepping down.

Example 36 includes the apparatus of any one or more of examples 25-35, wherein the first processor circuit is a matrix multiplication accelerator (MMA).

Example 37 includes the apparatus of any one or more of examples circuit-36, a power management circuit configurable to detect an idle operating state of the first processor circuit in an active power state, in response to the idle operating state, transition the first processor circuit to a first reduced power state, and in response to the first processor circuit remaining in the idle operating state after the transition to the first reduced power state, transition the first processor circuit to a second reduced power state, wherein the power management circuit supplies less power to the first processor circuit in the second reduced power state than in the first reduced power state.

Example 38 includes the device of example 37, wherein the power management circuit is configurable to, in response to detection of the first processor circuit exiting the idle operating state after the transition to the second reduced power state, transition the first processor circuit to the active power state.

Example 39 includes the device of example 38, wherein the power management circuit is configurable to initiate the transition to the active power state before the first processor circuit reaches the second reduced power state.

Example 40 includes the apparatus of any one or more of examples 37-39, wherein the power management circuit is configurable to detect the idle operating state of the first processor circuit based on an activity level of the first processor circuit.

Example 41 includes the apparatus of any one or more of examples 37-40, wherein the power management circuit is configurable to transition the first processor circuit to an idle power state via a plurality of intermediate reduced power states.

Example 42 includes the device of example 41, wherein the power management circuit is configurable to determine a quantity of intermediate power states based on a setting.

Example 43 includes the apparatus of any one or more of examples 41-42, wherein the power management circuit is configurable to determine a step size based on a setting.

Example 44 includes the apparatus of any one or more of examples 41-43, wherein the first processor circuit is a matrix multiplication accelerator (MMA).

Example 45 includes a method comprising detecting an idle operating state of a processor circuit while the processor circuit is in an active power state, stepping down power supplied to the processor circuit toward an idle power state in response to the detection of the idle operating state, detecting a transition of the processor circuit to an active operating state before the power has been stepped down to the idle power state, and stepping up the power supplied to the processor circuit to the active power state in response to the detection of the transition to the active operating state.

Example 46 includes the method of example 45, further comprising stepping the power to the processor circuit through at least two steps between the active power state and the idle power state.

Example 47 includes the method of any one or more of examples 45-46, further comprising stepping power to the processor circuit through at least two steps up while returning to the active operating state after starting to step power down.

Example 48 includes the method of any one or more of examples 45-47, further comprising controlling a power supplied to the processor circuit.

Example 49 includes the method of any one or more of examples 45-48, further comprising controlling a clock for the processor circuit.

Example 50 includes the method of any one or more of examples 45-49, wherein the processor circuit is a first processor circuit, the method further including controlling a first power state of the first processor circuit and a second power state of a second processor circuit.

Example 51 includes the method of any one or more of examples 45-50, further comprising controlling a first power domain and a second power domain.

Example 52 includes the method of any one or more of examples 45-51, further comprising determining a step size based on a register.

Example embodiments of the present disclosure are summarized here. Other embodiments can also be understood from the entirety of the specification and the claims filed herein.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. A device comprising:
a first processor circuit; and
power management circuit coupled to the first processor circuit and configurable to:
detect an idle operating state of the first processor circuit while the power management circuit is in an active power state;
initiate stepping down power to the first processor circuit towards an idle power state in response to detecting the idle operating state; and
transition the power to the first processor circuit to the active power state in response to detection of a transition of the first processor circuit to an active operating state before the power management circuit has stepped power down to the idle power state.

2. The device of claim 1,
wherein the first processor circuit includes a first slice and a second slice,
wherein the power management circuit is configurable to step down power to the first processor circuit towards the idle power state by deactivating the first slice while supplying power to the second slice.

3. The device of claim 2, wherein the power management circuit is configurable to transition the power to the first processor circuit to the active power state by activating the first slice while supplying power to the second slice.

4. The device of claim 1, wherein the power management circuit is configurable to detect the idle operating state by detecting that the first processor circuit is not processing data.

5. The device of claim 1, wherein the power management circuit is configurable to step the power to the first processor circuit through at least two steps between the active power state and the idle power state.

6. The device of claim 1, wherein the power management circuit is configurable to step power to the first processor circuit through at least two steps up while returning to the active power state after starting to step power down.

7. The device of claim 1, wherein the power management circuit is configurable to control a power state of the first processor circuit by controlling a power supplied to the first processor circuit.

8. The device of claim 1, wherein the power management circuit is configurable to control a power state of the first processor circuit by controlling a clock for the first processor circuit.

9. The device of claim 1,
wherein the device includes a second processor circuit, and
wherein the power management circuit is configurable to control a first power state of the first processor circuit and a second power state of the second processor circuit.

10. The device of claim 1, wherein the first processor circuit includes a first power domain and a second power domain.

11. The device of claim 1, further including a register to store a step size for the stepping down.

12. The device of claim 1, wherein the first processor circuit is a matrix multiplication accelerator (MMA).

13. A device comprising:
a first processor circuit;
a power management circuit configurable to:
detect an idle operating state of the first processor circuit in an active power state;
in response to the idle operating state, transition the first processor circuit to a first reduced power state; and
in response to the first processor circuit remaining in the idle operating state after the transition to the first reduced power state, transition the first processor circuit to a second reduced power state,
wherein the power management circuit supplies less power to the first processor circuit in the second reduced power state than in the first reduced power state.

14. The device of claim 13, wherein the power management circuit is configurable to, in response to detection of the first processor circuit exiting the idle operating state after the transition to the second reduced power state, transition the first processor circuit to the active power state.

15. The device of claim 14, wherein the power management circuit is configurable to initiate the transition to the active power state before the first processor circuit reaches the second reduced power state.

16. The device of claim 13, wherein the power management circuit is configurable to detect the idle operating state of the first processor circuit based on an activity level of the first processor circuit.

17. The device of claim 13, wherein the power management circuit is configurable to transition the first processor circuit to an idle power state via a plurality of intermediate reduced power states.

18. The device of claim 17, wherein the power management circuit is configurable to determine a quantity of intermediate power states based on a setting.

19. The device of claim 17, wherein the power management circuit is configurable to determine a step size based on a setting.

20. A method comprising:
detecting an idle operating state of a processor circuit while the processor circuit is in an active power state;
stepping down power supplied to the processor circuit toward an idle power state in response to the detection of the idle operating state;
detecting a transition of the processor circuit to an active operating state before the power has been stepped down to the idle power state; and
stepping up the power supplied to the processor circuit to the active power state in response to the detection of the transition to the active operating state.
